(19) United States
(12) Patent Application Publication
(10) Pub. No.: US 2013/0155325 A1
(43) Pub. Date: Jun. 20, 2013

(54) REGION OF INTEREST SELECTION, DECODING AND RENDERING OF PICTURE-IN-PICTURE WINDOW

(71) Applicants: Shailesh Ramamurthy, Bangalore (IN); Mahantesh Gowdra Chandrasekharappa, Bangalore (IN)

(72) Inventors: Shailesh Ramamurthy, Bangalore (IN); Mahantesh Gowdra Chandrasekharappa, Bangalore (IN)

(73) Assignee: GENERAL INSTRUMENT CORPORATION, Horsham, PA (US)

(21) Appl. No.: 13/328,681

(22) Filed: Dec. 16, 2011

(51) Int. Cl. H04N 5/45

(52) U.S. Cl. 348/565; 348/E05.112

(57) ABSTRACT

A method and computing device that allows a viewer to specify a Region of Interest (ROI) in a picture-in-picture (PIP) video signal, and displays only the ROI in the PIP window. The method displays a secondary video signal for a secondary program, and receives a boundary that defines an ROI on the secondary video signal. The method extracts a portion of the secondary video signal, where the portion extracted corresponds to the ROI. The method displays a primary video signal for a primary program in a main window, and displays the extracted portion of the secondary video signal in the main window where the portion of the secondary video signal overlays the primary video signal.

### BACKGROUND

Picture-in-Picture (PIP) is a feature available in television receivers, set-top boxes (STBs), and similar devices. The PIP feature allows a viewer to display a primary program (i.e., channel) in a main window (i.e., primary window) of a television screen and simultaneously display a secondary program (i.e., channel) in a secondary window (i.e., PIP window) that overlays the main window. The television typically plays the audio feed associated with the program displayed on the main window, and mutes the audio feed associated with the program displayed in the secondary window.

FIG. 1 illustrates a television display operating with a prior art PIP window system. The prior art PIP system shown in FIG. 1 displays the video signal from the primary program in the main window 110, and displays the video signal from the secondary program in the PIP window 120. The viewer has an option (not shown) to select the channel/program to be displayed in the PIP window 120 and once selected, the complete video information of the selected channel/program content will be displayed in the PIP window 120. The prior art only displays the entire program/image in the PIP window 120, but frequently, the viewer is only interested in a portion of the video signal from the secondary program (i.e., a Region of Interest (ROI)), not the complete video signal. For example, the viewer may be interested in a stock ticker or sports score, not the complete news or sports broadcast. In this case, the prior art systems do not allow the viewer to specify an ROI in the video signal from the secondary program and display only the ROI in the PIP window. Moreover, PIP prior implementations typically downscale the video associated with the secondary program, from full-size (full resolution) to a much smaller display area size. Hence, any text or other visual content that the user would specify as a region of interest using the present invention, especially when much smaller in relation to the secondary program video resolution/size, would get scaled down to an extent that makes the content in the region of interest unintelligible. For instance, when the entire resolution (video size) associated secondary program gets downscaled to a much smaller display area, a stock-ticker which may be the region of interest that a viewer would specify using the present invention, gets downscaled to an extent where the numbers within the stock ticker become unreadable by the viewer. As shown in FIG. 1, the PIP window 120 includes a stock ticker 121 displayed in a prior art implementation such that the stock ticker 121 in the PIP window 120 gets downscaled to an extent that the stock ticker 121 is not rendered in a readable form.

There is a need for a system and method that allows the viewer to specify an ROI in the PIP video signal, and displays only the ROI in the PIP window. The presently disclosed invention satisfies this demand.

### SUMMARY

Aspects of the present invention provide a method and computing device that allows a viewer to specify a Region of Interest (ROI) in a picture-in-picture (PIP) video signal, and displays only the ROI in the PIP window. The method displays a secondary video signal for a secondary program, and receives a boundary that defines an ROI on the secondary video signal. The method extracts a portion of the secondary video signal, where the portion extracted corresponds to the ROI. The method displays a primary video signal for a primary program in a main window, and displays the extracted portion of the secondary video signal in the main window where the portion of the secondary video signal overlays the primary video signal. In another aspect of the present invention, the method supports display of this extracted portion of the secondary video signal at full-size resolution, or at higher resolution, in relation to what is possible by prior implementations, thus maintaining intelligibility of visual content in the ROI to a user.

### BRIEF DESCRIPTION OF THE DRAWINGS

FIG. 1 illustrates a television display operating with a prior art PIP window system.

FIG. 2 illustrates a television display operating with a PIP window system according to one embodiment of the present invention.

FIG. 3 is a block diagram that illustrates one embodiment of the hardware components of a system that performs the present invention.

FIG. 4 is a flow diagram that illustrates a method of displaying an ROI as a PIP window according to one embodiment of the present invention.

FIG. 5 illustrates a user interface for selecting an ROI in a PIP window according to one embodiment of the present invention.

FIG. 6 illustrates an MPEG-2 video frame of a PIP window that includes an ROI.

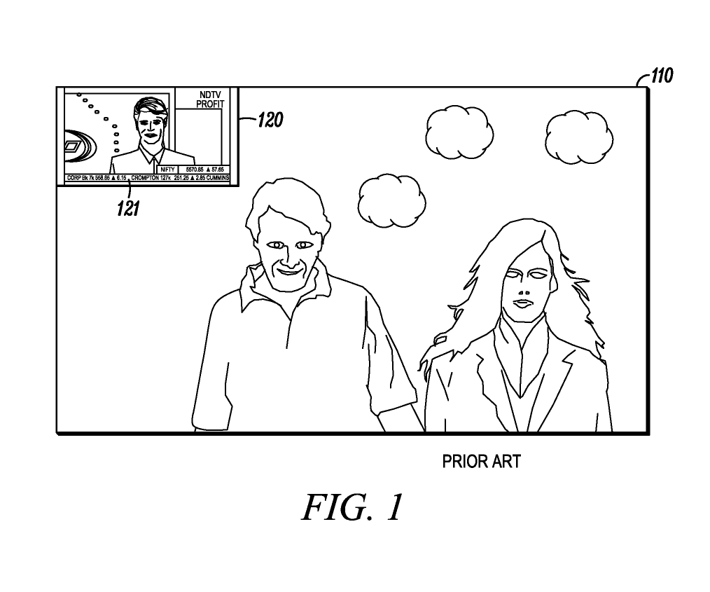

### DETAILED DESCRIPTION

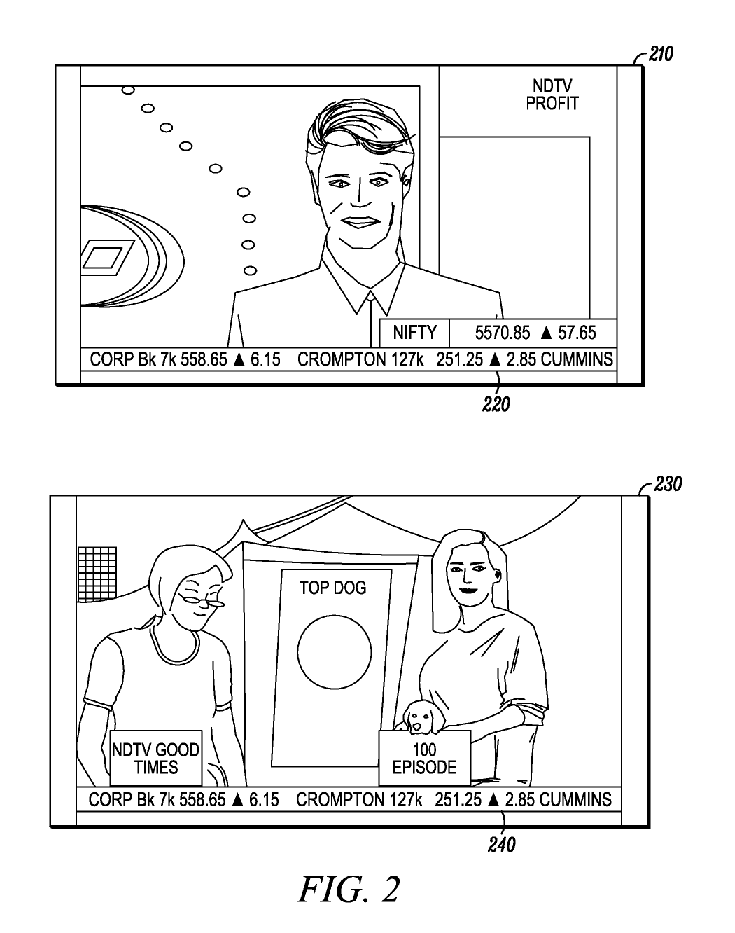

FIG. 2 illustrates a television display operating with a PIP window system according to one embodiment of the present invention. FIG. 2 shows a video frame displayed on the television display for a secondary program/channel 210 that the viewer would like to display using the PIP window system of the present invention. Since the viewer is not interested in displaying the entire video signal from the secondary program/channel 210 video frame, the viewer specifies a Region of Interest (ROI) 220 in the secondary program/channel 210. When the viewer accepts the selected ROI 220 and associates it with the secondary program/channel 210, the PIP window system of the present invention displays the ROI 220 in a PIP window 240 of a main window 230.

The present invention provides a mechanism for the viewer to specify the boundaries of the ROI 220. In one embodiment, the viewer makes a static choice of the ROI 220, for example, where a stock ticker will always occupy the same region in the video frame ‘canvas’. Once selected for a particular channel/program, the present invention stores the ROI 220 as part of user preferences. In another embodiment, the viewer uses an appropriate interactive mechanism to make a dynamic choice of the ROI 220 on the secondary program/channel 210 video frame ‘canvas’ after the viewer tunes to the channel for the secondary program/channel 210. In yet another embodiment, it is also possible that the ROI 220 is not always located at the same position in the secondary program/channel 210 video frame. In other words, the ROI 220 could move to other portions of the video frame. In cases where this motion is not very fast, video content or scene analysis detects the movement of the ROI 220 dynamically. In other words, the present invention will track and display the object present in a viewer's conceptual ROI 220 even though it moves to a new ‘absolute coordinate’ location on the grid of the video frame of the secondary program/channel 210. In yet another embodiment, the viewer may select multiple ROIs 220 in the secondary program/channel 210 video frame. Under such an option, the present invention will display the ROIs 220 in the secondary program 210 in a juxtaposed fashion. If the viewer prefers to watch only one of the specified ROIs, the viewer has the option to switch between the ROIs 220 selected in the same program or channel.

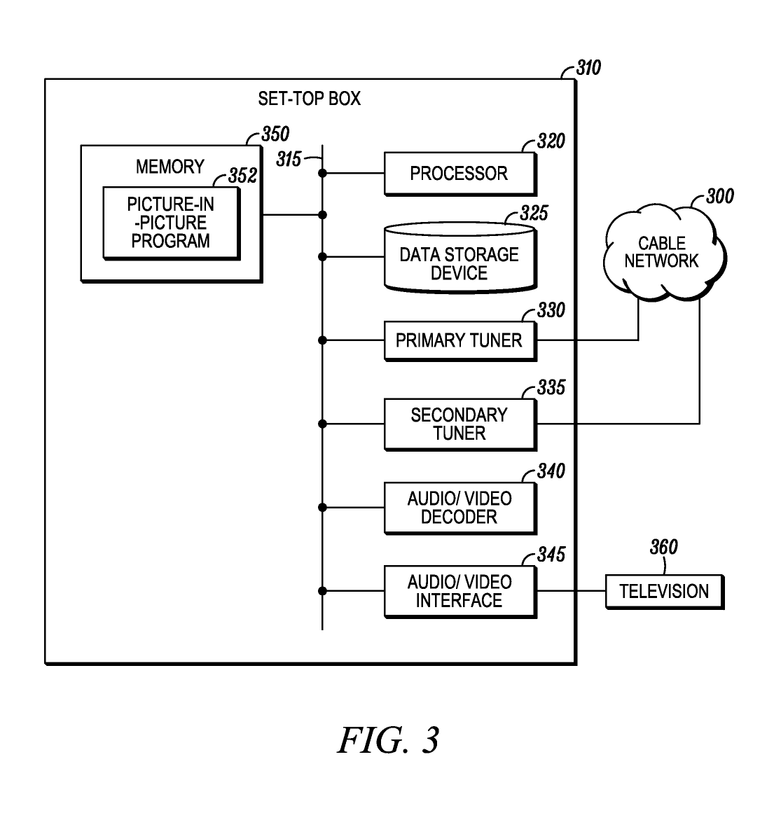

FIG. 3 is a block diagram that illustrates one embodiment of the hardware components of a system that performs the present invention. A cable network 300 is a two-way broadband network, such as a hybrid fiber-coaxial (HFC) network, that provides cable programming to a cable subscriber. The cable subscriber operates a computing device, such as a set-top box 310 to receive and decode the cable programming from the cable network 300, and display the cable programming on a display device, such as a television 360.

The set-top box 310 shown in FIG. 3, in one embodiment, is a general-purpose computing device that performs the present invention. A bus 315 is a communication medium connecting a processor 320, data storage device 325 (such as a serial ATA (SATA) hard disk drive, optical drive, small computer system interface (SCSI) disk, flash memory, or the like), primary tuner 330, secondary tuner 335, audio/video decoder 340, audio/video interface 345, and memory 350 (such as random access memory (RAM), dynamic RAM (DRAM), non-volatile computer memory, flash memory, or the like). The primary tuner 330 and secondary tuner 335 connect the set-top box 310 to the cable network 300. The audio/video interface 345 connects the set-top box 310 to the television 360. In one embodiment, a user (not shown) operates a radio-frequency (RF) remote controller to communicate with the set-top box 310 via the television 360 and audio/video interface 345. In another embodiment, a keypad (not shown) is a user interface to the set-top box 310. In one embodiment, the implementation of the present invention on the set-top box 310 is an application-specific integrated circuit (ASIC).

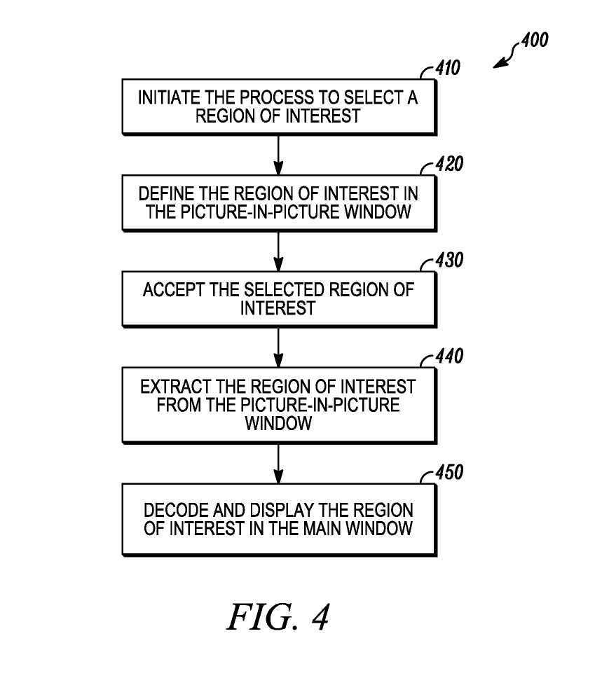

The processor 315 performs the disclosed methods by executing the sequences of operational instructions that comprise each computer program resident in, or operative on, the memory 350. The reader should understand that the memory 350 may include operating system, administrative, and database programs that support the programs disclosed in this application. In one embodiment, the configuration of the memory 350 of the set-top box 310 includes a Picture-in-Picture (PIP) program 352 that performs the method of the present invention disclosed in detail in FIG. 4. When the processor 315 performs the disclosed methods, it stores intermediate results in the memory 350 or data storage device 325. In another embodiment, the processor 315 may swap programs, or portions thereof, in and out of the memory 350 as needed, thus the memory 350 may include fewer than all of these programs at any one time.

FIG. 4 is a flow diagram that illustrates a method of displaying an ROI as a PIP window according to one embodiment of the present invention. The process 400 shown in FIG. 4 begins when a viewer initiates the process to select an ROI (step 410). In one embodiment, the viewer initiates the process by selecting a menu option on a set-top box 310 user interface. The channel/program that the set-top box 310 is receiving when the viewer initiates the process is the PIP window (i.e., target window) in which the viewer will define the boundaries that define the Region of Interest (step 420).

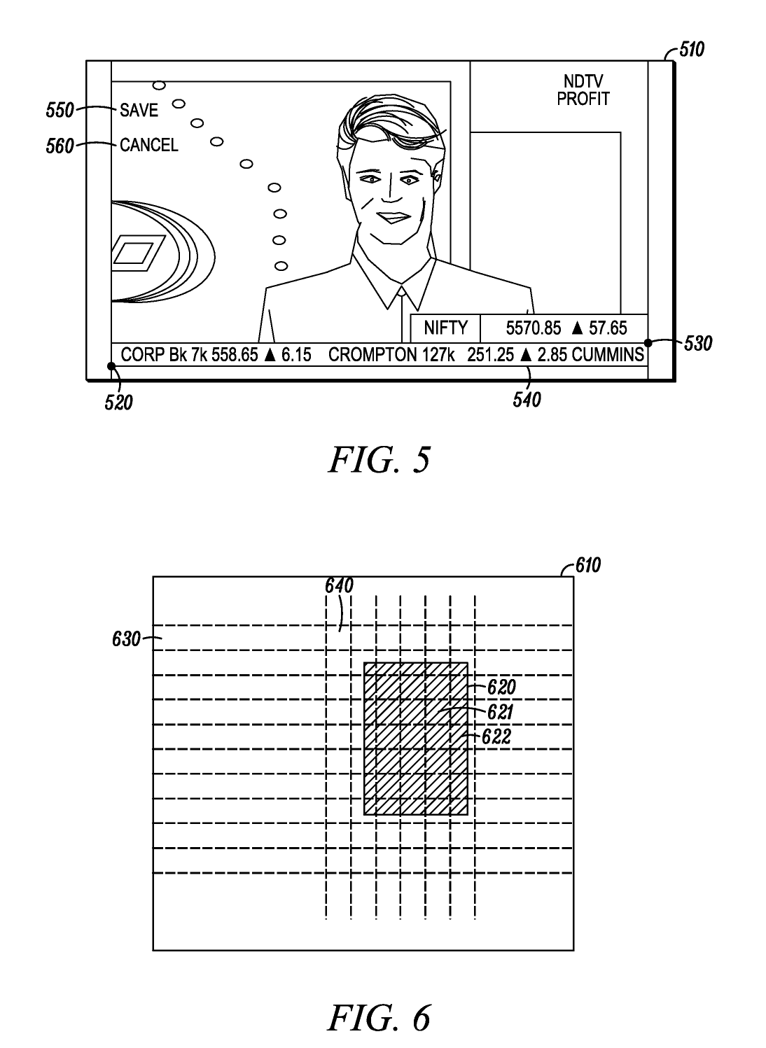

FIG. 5 illustrates a user interface for selecting an ROI in a PIP window according to one embodiment of the present invention. The viewer uses a remote control device to communicate with the set-top box 310 and operate the user interface shown in FIG. 5. For example, the “1” button allows the viewer to define the bottom-left corner 520 of the ROI 540 in the PIP window 510, the “2” button allows the viewer to define the top-right corner 530 of the ROI 540, the “Save” 550 menu option saves the ROI 540 selection, and the “Cancel” 560 menu option cancels the ROI 540 selection.

Referring to FIG. 5, when the viewer presses the “1” button on the remote control, a graphical point appears at the bottom-left portion of the PIP window 510. The graphical point will blink to indicate that the viewer can move it to a desired location of the bottom-left corner 520 of the ROI 540. The viewer will use the left, right, top, and bottom arrow buttons on the remote control to navigate the movement of the graphical point to the desired location 520. Similarly, when the viewer presses the “2” button on the remote control, a second graphical point appears at the top-right portion of the PIP window 510. The second graphical point will blink to indicate that the viewer can move it to a desired location of the top-right corner 530 of the ROI 540. The viewer will use the left, right, top, and bottom arrow buttons on the remote control to navigate the movement of the second graphical point to the desired location 530.

Referring to FIG. 4 and FIG. 5, once the viewer has set the desired location 520, 530 for both graphical points, the process 400 displays the defined ROI 540 as a rectangular area drawn on the PIP window 510. The viewer may change the ROI 540 by moving either of the graphical points 520, 530. When the viewer is satisfied with the boundaries of the ROI 540, pressing the “Save” 550 menu option saves (i.e., accepts) the ROI 540 selection (step 430), and the “Cancel” 560 menu option cancels the ROI 540 selection. Once the viewer has selected the ROI 540, the process 400 performs video processing of the data in the ROI 540 by extracting the ROI 540 from the video signal for the PIP window 510 (step 440), and decoding and displaying the ROI 540 and the video signal for the primary program in the main window (step 450) such that the ROI 540 overlays the video signal for the primary program.

When a viewer selects to display a particular channel or program in the PIP window, the process 400 will check a predefined storage area on the embedded device to determine whether the viewer has defined a ROI 540 for the selected channel or program. If a ROI 540 is not present for the selected channel, then the process 400 will display the complete program or channel content in the PIP window. The viewer will also have an option to select the ROI 540 dynamically while selecting the image to be displayed in the PIP window or when PIP window display is on. When a viewer selects multiple ROIs 540 for a particular channel or program, the viewer will have an option to switch between each selected ROI 540.

The present invention provides a mechanism for the ROI selected by the viewer to be overlaid on top of another channel. The ROI is selected on a video signal for a secondary video channel, and the overlay occurs on a primary video channel where the primary tuner and secondary tuner tune, respectively, to primary and secondary channels. After tuning and demodulation as per need, both channels are decoded as described below. The present invention allows the user to select the ROI on the secondary channel, then ‘pastes’ the selected ROI into the primary channel. The resulting effect is analogous to a video wall or a multivideo display that mashes-up multiple videos onto a single screen. We first describe embodiments that effect this overlaying after decoding the secondary channel in entirety. In other words, such embodiments use the secondary tuner to tune to the secondary channel, decode it in its entirety, and overlay the chosen ROI on top the primary channel.

It is known to one skilled in the art that picture elements (pixels) from two video streams, that is to say video signal streams associated with the primary and secondary channels can be combined or blended in accordance with a parameter known as transparency level that can be varied from pixel to pixel in the most generic case. The term transparency level utilized herein should be understood to refer to the extent a video image is visible when blended with another video image, when the blending is in accordance with defined transparency values on a per-pixel basis. In many systems that implement the transparency levels, the said transparency levels form a separate channel known as alpha transparency channel. Without loss of generality, the stated blending operation can be described as a weighted average of the pixels from primary and secondary channel to produce the blended video, the degree of weighting being allowed to be controlled by the transparency level that can be defined on a per-pixel basis. At one end of the values that the transparency level parameter can take, the transparency level parameter is associated with ‘opaque’ secondary channel pixel(s) that completely obscure(s) the primary channel pixel it is overlaid upon. An ‘opaque’ secondary channel pixel means that only the secondary channel pixel at the pixel location is visible, and not the primary channel pixel at that location. At the other end of the values that the transparency level parameter can take, the transparency level parameter is associated with ‘transparent’ secondary channel pixel(s) completely invisible and it only the primary channel pixel(s) that are overlaid upon which is/are visible. The simplest form of this invention employs an overlay mask to render all the pixels in the chosen ROI on the video signal for the secondary channel to be opaque and all the pixels in regions outside the chosen ROI to be transparent. It should also be noted that the present invention differentiates itself from other PIP implementations in that the chosen ROI which is opaque is displayed in full-size resolution and is not downscaled, or downscaled to the extent that secondary channels are normally downscaled to, in prior art PIP implementations. In a specialized case of one embodiment of the present invention that uses transparency levels as just described, the user may adjust the level of transparency can view both the secondary and primary channel pixels overlaid together. Such an adjustment could be as per individual user preferences and/or the colors of the ROI in relation to the primary channel pixels, the adjustment including both automatic or manual (via remote-control key) adjustments.

When the content of the ROI 540 is displayed, the process 400 monitors the displayed content. If there is any movement of the image (e.g., movement of user faces), then the display is moved accordingly to ensure that the viewer interested content is always displayed even though it has moved to another location on the screen. U.S. Pat. No. 6,298,170 describes such a method for tracking the content of an image that moves on a display. In one embodiment, the viewer will have an option to disable content monitoring by the process 400, thereby only displaying the portion of the screen that the viewer has selected all the time.

There are several prior art methods to perform the video processing of the data in the ROI 540 (step 440 and step 450). FIG. 6 illustrates an MPEG-2 video frame of a PIP window that includes an ROI. FIG. 6 shows a portion of an MPEG-2 video frame 610 that is displayed in the PIP window 510 and that includes an ROI 620. In the context of MPEG-2 video, the video frame 610 comprises a number of slices 630, where each slice 630 includes a number of macroblocks 640. In another embodiment, MPEG-4 Advanced Video Coding (AVC) video would use Network Abstraction Layer (NAL) units as the construct that is analogous to slices 630.

Having described mechanisms for embodiments that operate on the decoded pixels of the secondary channel after the decoding of secondary channel is carried out, the following describes an embodiment where the decoding can be carried out selectively on the secondary channel after the ROI has been selected. In other words, the parts of the compressed stream that are associated with the ROI are first determined, followed by decoding of pixels associated with only the chosen ROI.

As shown in FIG. 6, the ROI 620 includes macroblocks 640 that are completely inside 621 the ROI 620, and macroblocks 640 that are partially inside 622 the ROI 620. The video processing excludes the video frame 610 data from regions that are above, below, right, and left of the ROI 620. Since a video bitstream typically contains macroblocks 640 as a syntactic element, the present invention preserves coded data of macroblocks 640 that are completely inside 621 or partially inside 622 the ROI 620.

Conceptually, the data corresponding to the macroblocks 640 completely outside the ROI 620 can be removed. However, the blocks that are not needed may still have implications on the coded bitstream structure.

Two aspects of data removal from the unused regions are: (a) identifying and ignoring macroblocks 640 whose contributions are not relevant to the ROI 620; and (b) identifying and removing DCT Coefficients whose contributions are not relevant to the ROI 620. Both of these aspects of data removal are performed in the compressed domain on MPEG-2 streams. The aforementioned aspect (a), removal of non-relevant macroblocks 640, can be performed on P and B frames, but not on I frames. The aforementioned aspect (b), removal of non-relevant DCT coefficients, can be applied on I, P, and B frames. When aspect (a) and/or aspect (b) are applied, the stream can be said to be specifically conditioned. When a decoder decodes such a conditioned stream, it will be able to decode it without any trouble because the modifications ensure the standard conformance of the stream. It must be noted that the video obtained by decoding the ROI 620 edited stream, regions outside the ROI 620 may contain invalid (i.e., corrupt) data. This would not pose an issue, given that the video outside the Region of Interest 620 is not used for display after decoding.

Regions Above and Below the ROI—Skipping Macroblocks for P and B Frames

Slices 630 can be located in an MPEG-2 stream by virtue of start code.

The macroblocks 640 in the regions completely above and below the ROI 620 are associated with one or more complete slices 630 from the left edge to the right edge of the video frame.

The slice 630 start code indicates the vertical position and thus whether it is inside or outside the ROI 620. Note that the first and last macroblocks 640 in a slice 630 should be preserved (i.e., they cannot be skipped macroblocks 640) as per MPEG-2 video.

In the slices 630 completely above and below the ROI 620, the macroblocks 640 except the first and last are skipped. For every macroblock 640 skipped, the macroblock 640 address increment of the next coded macroblock 640 is increased by one. In cases where all the macroblocks 640 in a slice 630 are skipped except the first and last, the macroblock-address-increment of the last macroblock 640 is modified accordingly. The beginning of macroblock 640 data is identified by the fixed length macroblock 640 escape (if it exists) and the VLC corresponding to the macroblock 640 address increment, since the macroblock 640 data doesn't begin with a start code or with a header.

In order to implement the skipping of macroblocks 640, the stream must be partially decoded as specified in the standard. Partial decoding is required to identify the beginning of each macroblock 640. VLC decoding of DCT coefficients is also required to move through a block's data to identify its end and to locate the beginning of the next macroblock 640. However, steps like reverse zig-zag scanning, de-quantization, and IDCT are not performed.

This approach helps to remove the majority of the data associated with the slices 630 above and below the Region of Interest 620.

As a result, the actual macroblock 640 structure of these slices 630 are altered. For example, an intra-coded macroblock 640 within the slice 630 is also skipped.

The motion vectors associated with the macroblocks 640 that are skipped are lost. When a decoder encounters parts of a video stream modified through the procedure that skips macroblocks 640 not relevant to ROI 620, it reconstructs the video in the skipped macroblocks 640 from previously decoded frames through prediction.

As a result, regions corresponding to these macroblocks 640 in the reconstructed video are corrupt, but are eventually discarded at the display as it is outside the ROI 620 and will not be visible. When macroblocks 640 are removed this way, it may cause problems for the macroblocks 640 whose motion vectors point to these skipped macroblocks 640. We want to ensure that all data inside the ROI 620 can be decoded correctly. However, it is possible that the motion vector of a macroblock 640 inside the ROI 620 points to a region outside the ROI 620. To overcome this problem, portions of data in the immediate neighborhood of the ROI 620 are left untouched. This immediate neighborhood of pixels surrounding the ROI 620 also needs to be decoded correctly.

For a PIP Window in this embodiment, let us consider that there is only one object of interest (a ticker, or a newscaster's head) and its motion is not normally fast. Experiments have determined that a neighborhood of 2 slices 630 above and below works well under normal conditions.

Regions to the Right of the ROI—Skipping Macroblocks for P and B Frames

Macroblocks 640 that completely inside 621 the ROI 620 are retained.

Macroblocks 640 that are partially inside 622 the ROI 620 are retained too.

Macroblocks 640 on the right side of the ROI 620 are skipped except the last one in a slice 630.

Macroblocks 640 on the right side of the ROI 620 are skipped using the procedure that skips macroblocks 640, as described in the previous section.

To create the “neighborhood pixels” (i.e., to support motion vectors pointing outside the ROI 620), a few macroblocks 640 after the ROI 620 boundary on the right side are also retained. The macroblock 640 address increment of the last macroblock 640 is updated to reflect the number of skipped macroblocks 640.

Regions Outside the ROI—Deleting DCT Coefficients for I Frames

Since I frames have only intra coded macroblocks 640, it is not possible to skip macroblocks 640 on I pictures.

However, deleting DCT coefficients can be applied in the regions outside the ROI 620 on I frames, similar to our editing of P or B frames.

This deletion procedure is performed on all blocks in the macroblocks 640 in the I frame outside the ROI 620 with an initial neighborhood of 2 macroblocks 640. Only the DC coefficient is retained and all the AC coefficients are deleted until the End of Block (EOB).

Regions to the Left of the ROI—Deleting DCT Coefficients for P and B Frames

Portions of the video in the coded stream corresponding to the left side of the ROI 620 need special handling. There is predictive coupling for the motion vectors from macroblocks 640 on the left side to the right side in a slice 630. Thus, if a macroblock 640 is skipped, the motion vectors of the subsequent macroblocks 640 that are inside the ROI 620 are not decoded correctly.

The contents of the macroblock 640 on the left side of the ROI 620 should be retained while the actual pixel data coded through DCT coefficients can be modified. To reduce data in unwanted regions on the left side of a ROI, we delete DCT coefficients in all blocks with coded data. A neighborhood of pixels is also maintained in this case by keeping a few unedited macroblocks 640 on the left side of the ROI 620. All other blocks in a macroblock 640 that have coded data are modified.

Each macroblock 640 consists of six blocks. In each block, the DCT coefficients after quantization are VLC coded in the run, level, and sign format. The End of Block (EOB) code defined in the standard is used to indicate the end of DCT coefficients. For these blocks, the first VLC coded data (DC coefficient) is retained, the rest of the VLC coded data is deleted, and finally the EOB code is retained. According to the standard, the first data in a block cannot be EOB. So we keep a VLC code and an EOB in such blocks. When a decoder decodes the stream modified this way, after the EOB it fills any remaining DCT coefficients with zeros. So the decoded video in these regions is corrupt, but it does not matter since this part of the video is discarded before display.

The present invention provides several advantages. The present invention discloses a novel system and method that allows the viewer to select an ROI in a PIP video signal, and display only that particular ROI rather than the entire video signal. In addition, the present invention tracks the ROI even when the viewer moves the PIP window to another location in the main window. Furthermore, when a prior art PIP window system displays the video signal from the secondary program in the PIP window, the resolution of the PIP window makes it difficult to read text or recognize visual objects. However, since the PIP window of the present invention only displays an ROI in the secondary program, the viewer is able to discern details in the secondary program. For example, a stock ticker downscaled for presentation of an entire video frame of a tuned channel would make the numbers on the ticker unreadable, but if the viewer wants to keep a tab on the numbers without swapping primary and secondary video windows, this invention enables that use case.

Although the disclosed embodiments describe a fully functioning method and computing device that allows the viewer to specify an ROI in the PIP video signal, and displays only the ROI in the PIP window, the reader should understand that other equivalent embodiments exist. Since numerous modifications and variations will occur to those reviewing this disclosure, the method and computing device that allows the viewer to specify an ROI in the PIP video signal, and displays only the ROI in the PIP window is not limited to the exact construction and operation illustrated and disclosed. Accordingly, this disclosure intends all suitable modifications and equivalents to fall within the scope of the claims.

We claim:

1. A method, comprising:
displaying a secondary video signal for a secondary program;
receiving a boundary that defines a Region of Interest (ROI) on the secondary video signal;
extracting a portion of the secondary video signal, the portion corresponding to the ROI;
displaying a primary video signal for a primary program in a main window; and
displaying the portion of the secondary video signal in the main window, wherein the portion of the secondary video signal overlays the primary video signal.

2. The method of claim 1, wherein the displaying of the secondary video signal further comprises:
receiving a request to tune to the secondary program;
tuning a secondary tuner to the secondary program in response to the request;
receiving the secondary video signal; and
displaying the secondary video signal for the secondary program.

3. The method of claim 1, wherein the receiving of the boundary that defines the ROI further comprises:
storing the boundary that defines the ROI on the secondary video signal as a preference for a user,
wherein the preference is associated with the secondary program.

4. The method of claim 1, wherein the receiving of the boundary that defines the ROI further comprises:
creating an overlay mask for the displaying of the primary video signal and the portion of the secondary video signal in the main window,
wherein the overlay mask defines a visibility characteristic for pixels in the primary video signal and the secondary video signal, the visibility characteristic determining whether the pixel from the primary video signal or the secondary video signal is visible.

5. The method of claim 4, wherein the visibility characteristic for each pixel in the ROI is opaque, thereby making the secondary video signal visible, and wherein the visibility characteristic for each pixel outside the ROI is transparent, thereby making the primary video signal visible.

6. The method of claim 1, wherein the receiving of the boundary that defines the ROI further comprises:
receiving at least two coordinates corresponding to pixels of the secondary video signal,
wherein said at least two coordinates define a shape of the boundary that defines the ROI.

7. The method of claim 6, wherein the receiving of said at least two coordinates further comprises:
receiving a first coordinate that defines a bottom-left corner of the ROI; and
receiving a second coordinate that defines a top-right corner of the ROI.

8. The method of claim 1, wherein the portion of the secondary video signal includes video content, and wherein the displaying of the portion of the secondary video signal in the main window is of the video content in full-size resolution.

9. The method of claim 1, further comprising:
analyzing a scene in the secondary program to determine when video content in the ROI moves to another location in the secondary video signal; and
moving the ROI to the other location in the secondary video signal.

10. A computing device, comprising:
a memory device resident in the computing device; and
a processor disposed in communication with the memory device, the processor configured to:
display a secondary video signal for a secondary program;
receive a boundary that defines a Region of Interest (ROI) on the secondary video signal;
extract a portion of the secondary video signal, the portion corresponding to the ROI;
display a primary video signal for a primary program in a main window; and
display the portion of the secondary video signal in the main window, wherein the portion of the secondary video signal overlays the primary video signal.

11. The computing device of claim 10, wherein to display the secondary video signal, the processor is further configured to:
receive a request to tune to the secondary program;
tune a secondary tuner to the secondary program in response to the request;
receive the secondary video signal; and
display the secondary video signal for the secondary program.

12. The computing device of claim 10, wherein to receive the boundary that defines the ROI, the processor is further configured to:
store the boundary that defines the ROI on the secondary video signal as a preference for a user,
wherein the preference is associated with the secondary program.

13. The computing device of claim 10, wherein to receive the boundary that defines the ROI, the processor is further configured to:
create an overlay mask for the display of the primary video signal and the portion of the secondary video signal in the main window,
wherein the overlay mask defines a visibility characteristic for pixels in the primary video signal and the secondary video signal, the visibility characteristic determining whether the pixel from the primary video signal or the secondary video signal is visible.

14. The computing device of claim 13, wherein the visibility characteristic for each pixel in the ROI is opaque, thereby making the secondary video signal visible, and wherein the visibility characteristic for each pixel outside the ROI is transparent, thereby making the primary video signal visible.

15. The computing device of claim 10, wherein to receive the boundary that defines the ROI, the processor is further configured to:
receive at least two coordinates corresponding to pixels of the secondary video signal,
wherein said at least two coordinates define a shape of the boundary that defines the ROI.

16. The computing device of claim 15, wherein to receive said at least two coordinates, the processor is further configured to:
receive a first coordinate that defines a bottom-left corner of the ROI; and
receive a second coordinate that defines a top-right corner of the ROI.

17. The computing device of claim 10, wherein the portion of the secondary video signal includes video content, and wherein the displaying of the portion of the secondary video signal in the main window is of the video content in full-size resolution.

18. The computing device of claim 10, wherein the processor is further configured to:
analyze a scene in the secondary program to determine when video content in the ROI moves to another location in the secondary video signal; and
move the ROI to the other location in the secondary video signal.

19. A non-transitory computer-readable medium, comprising computer-executable instructions that, when executed on a computing device, perform steps of:
displaying a secondary video signal for a secondary program;
receiving a boundary that defines a Region of Interest (ROI) on the secondary video signal;
extracting a portion of the secondary video signal, the portion corresponding to the ROI;
displaying a primary video signal for a primary program in a main window; and
displaying the portion of the secondary video signal in the main window, wherein the portion of the secondary video signal overlays the primary video signal.
